(19) United States
(12) Patent Application Publication
(10) Pub. No.: US 2024/0179658 A1
(43) Pub. Date: May 30, 2024

(54) METHODS AND DEVICES FOR TIME SYNCHRONIZATION

(71) Applicant: Telefonaktiebolaget LM Ericsson (PUBL), Stockholm (SE)

(72) Inventors: Zhenhua Zou, SOLNA (SE); Zhipeng Lin, NANJING (CN); Yufei Blankenship, KILDEER, IL (US)

(21) Appl. No.: 18/552,467

(22) PCT Filed: Mar. 30, 2022
(86) PCT No.: PCT/IB2022/052948

§ 371 Date: Sep. 26, 2023

(30) Foreign Application Priority Data
Mar. 30, 2021 (WO) PCT/CN2021/084178

(51) Int. Cl. H04W 56/00

(52) U.S. Cl. CPC H04W 56/0045

(57) ABSTRACT

A method (1600) implemented by a terminal device (600) is provided. The method includes transmitting (1602) information about a first preference of the terminal device to use a timing advance, TA, based propagation delay estimation or a round-trip time, RRT, based propagation delay estimation. For example, the first preference may include at least one of: a preference of the terminal device for at least one downlink reference signal; a preference of the terminal device for at least one uplink reference signal; and a preference of the terminal device for at least one physical random access channel, PRACH, transmission on an uplink. As another example, the first preference indicates a preference of the terminal device to use a network node based propagation delay estimation or a terminal device based propagation delay estimation.

### TECHNICAL FIELD

The present disclosure generally relates to the field of time synchronization, and more particularly to methods and devices for time synchronization in a time sensitive network (TSN).

### BACKGROUND

For supporting time sensitive network (TSN) time synchronization, the 5^{th} generation system (5GS) is integrated with the external network as a TSN bridge (or a time-aware system). There are two synchronization systems considered: the 5GS synchronization and the TSN domain synchronization. 5GS synchronization is specified in 3GPP specifications for Next Generation Random Access Network (NG RAN) synchronization while TSN domain synchronization follows IEEE 802.1AS and provides synchronization services to the TSN network.

5GS time synchronization needs to satisfy stringent accuracy requirement in order to support inter-working with TSN. A demanding use case in the context of TSN-5GS interworking is when TSN Grandmaster clocks are located at end stations connected to user equipment (UE)/device side TSN translators (DS-TTs). This new Rel-17 use case involves two Uu interfaces in the 5GS path (i.e. the 5GS ingress to the 5GS egress) over which a TSN Grandmaster clock is relayed. One variant of the use case is illustrated in FIG. 1, which shows TSN end-to-end timing delivery where the ingress is at a first UE (UE1), wherein two UEs may be connected to different gNodeBs (gNBs), thereby introducing the potential for increased uncertainty compared to the case where each UE is connected to the same gNB.

The 5GS synchronicity budget is the portion of the end-to-end synchronicity budget applicable between the ingress and egress of the 5G system, as shown in FIG. 1. The per Uu interface synchronization error represents a portion of the end-to-end synchronicity budget and consists of the uncertainty introduced when (a) sending the 5G reference time from gNB antenna to the UE antenna by including ReferenceTimeInfo in either a DLInformationTransfer RRC (radio resource control) message or SIB9 and then (b) adjusting the 5G reference time to reflect the downlink propagation delay.

The range of uncertainty for a single Uu interface shown in Table 1 below was agreed at 3GPP TSG-RAN WG2 #113-e.

TABLE 1
Range of Uncertainty for a Single Uu interface

| Scenario | Single Uu interface Budget |
|---|---|
| Control-to-Control | ±145 ns to ±275 ns |
| Smart Grid | ±795 ns to ±845 ns |

The Rel-17 Radio Access Network (RAN) work item “Enhanced Industrial Internet of Things (IoT) and ultra-reliable and low latency communication (URLLC) support for New Radio (NR)” has the following objective, where propagation delay compensation is used to achieve time synchronization between the UE and its associated gNB:
Enhancements for support of time synchronization:
a. RAN impacts of SA2 work on uplink time synchronization for TSN, if any. [RAN2]
b. Propagation delay compensation enhancements (including mobility issues, if any). [RAN2, RAN1, RAN3, RAN4].

As agreed by RAN1 in RAN1 #102e, the following options for propagation delay compensation are further studied in RAN1:
Option 1: TA-based propagation delay
   Option 1a: Propagation delay estimation based on legacy timing advance (TA) (potentially with enhanced TA indication granularity),
   Option 1b: Propagation delay estimation based on timing advanced enhanced for time synchronization (similar to 1a but with updated RAN4 requirements to TA adjustment error and Te),o Option 1c: Propagation delay estimation based on a new dedicated signaling with finer delay compensation granularity (separated signaling from TA so that TA procedure is not affected);
Option 2: RTT based delay compensation:
   Propagation Delay Estimation Based on an RAN Managed Receiver-Transmitter (Rx-Tx) procedure intended for time synchronization (to expand or separate procedure/signaling to positioning).

### TA Based Propagation Delay Compensation

Timing Advance (TA or T_{ADV}) command is utilized in cellular communication for uplink transmission synchronization. It is further classified as two types:
1. In the beginning, at connection setup, an absolute timing advance command is communicated to a UE in the medium access control (MAC) Protocol Data Unit (PDU) Random Access Response (RAR) or in the Absolute Timing Advance Command MAC Control Element (CE) of the MSGB.
2. After connection setup, a relative timing correction can be sent to a UE using Timing Advance Command MAC CE (e.g., UEs can move or due to multi-path because of changing environment).

The downlink Propagation Delay can be estimated for a given UE by (a) first summing the TA value indicated by the RAR and all subsequent TA values sent using the MAC CE and (b) taking some portion of the total TA value resulting from summation of all the TA values (e.g. 50% could be used assuming the downlink and uplink propagation delays are essentially the same). The propagation delay can be utilized to understand time synchronization dynamics, e.g., accurately tracking the value of a clock at UE side relative to the value of that clock in other network nodes.

### RTT Based Propagation Delay Compensation

For the round-trip time (RTT) based method, the UE Rx-Tx Time Difference and/or gNB Rx-Tx Time Difference are measured at UE side and gNB side, respectively, and then used to derive the propagation delay.

For instance, two types of TA can be defined:
Type1: T_{ADV}=(gNB Rx−Tx time difference)+(UE Rx−Tx time difference);
Type2: T_{ADV}=gNB Rx−Tx time difference;

With either Type 1 or Type 2, the propagation delay can be estimated as ½*T_{ADV}.

For Type 2 T_{ADV}, the Rx−Tx time difference corresponds to a received uplink radio frame containing Physical Random Access Channel (PRACH) from the respective UE.

### UE Assistance Information

When configured to do so, the UE can signal the network through the Radio Resource Control (RRC) message UEAssistanceInformation, which may include the UE's preference/expectations for several aspects of operation.

FIG. 2 illustrates transmission of RRCReconfiguration and UEAssistanceInformation between the UE and the network node.

One aspect is that the UE can signal if it prefers (not) to be provisioned with reference time information.

The network configuration is done in an RRCReconfiguration message that contains an Information Element (IE), OtherConfig. If the network configures the UE to provide the preference of reference time delivery, the network sets the field value reference TimePreferenceReporting-r16 to be true.

| | |
|---|---|
| OtherConfig-v1610 ::= | SEQUENCE { |

referenceTimePreferenceReporting-r16 ENUMERATED {true}
}

If configured, the UE initializes the transmission of the preference 1) the first time it has been configured to provide the preference; 2) or its preference changed from the last time the UE initiated the transmissions. This behavior is described in subclause 5.7.4.2 from 3GPP TS 38.331 as follows:
1> if configured to provide preference in being provisioned with reference time information:
   2> if the UE did not transmit a UEAssistanceInformation message with referenceTimeInfoPreference since it was configured to provide preference; or
   2> if the UE's preference changed from the last time UE initiated transmission of the UEAssistanceInformation message including referenceTimeInfoPreference:
      3> initiate transmission of the UEAssistanceInformation message in accordance with 5.7.4.3 to provide preference in being provisioned with reference time information.

The indication is a Boolean value in which “true” indicates that the UE prefers to be provided with reference time, and “false” indicates otherwise. This is described in the Information Element (IE) from subclause 6.3.2 from 3GPP TS 38.331 as follows:

UEAssistanceInformation-v1610-IEs ::= SEQUENCE {

| | |
|---|---|
| idc-Assistance-r16 | IDC-Assistance-r16 |

OPTIONAL,

| | |
|---|---|
| drx-Preference-r16 | DRX-Preference-r16 |

OPTIONAL,

| | |
|---|---|
| maxBW-Preference-r16 | MaxBW-Preference-r16 |

OPTIONAL,

| | |
|---|---|
| maxCC-Preference-r16 | MaxCC-Preference-r16 |

OPTIONAL,

| | |
|---|---|
| maxMIMO-LayerPreference-r16 | MaxMIMO- |

LayerPreference-r16 OPTIONAL,
minSchedulingOffsetPreference-r16

| | |
|---|---|
| MinSchedulingOffsetPreference-r16 | OPTIONAL, |
| releasePreference-r16 | ReleasePreference-r16 |

```
OPTIONAL,
  sl-UE-AssistanceInformationNR-r16 SL-UE-
AssistanceInformationNR-r16 OPTIONAL,
  referenceTimeInfoPreference-r16 BOOLEAN
OPTIONAL,
```

| | |
|---|---|
| nonCriticalExtension | SEQUENCE { } |

OPTIONAL
}

Once triggered, the UE can set the value according to its preference. This is described in subclause 5.7.4.3 from 3GPP TS 38.331 as follows:
1> if transmission of the UEAssistanceInformation message is initiated to provide an indication of preference in being provisioned with reference time information according to 3GPP TS 38.331 section 5.7.4.2 or 5.3.5.3:
   2> if the UE has a preference in being provisioned with reference time information:
      3> set referenceTimeInfoPreference to true;
   2> else:
      3> set referenceTimeInfoPreference to false.

In NR up to Rel-16, the UE can signal if it prefers (or prefers not) to be provisioned with reference time information. However, there is no indication of other information that helps with a better and (most often than not) a required clock synchronization, which is typically achieved via propagation delay estimation and compensation. In addition, TSN and non-TSN UEs needs to be differentiated so that the TSN specific features can be enabled for TSN UEs, which is not necessary for non-TSN UEs for better resource utilization efficiency.

### SUMMARY

The present disclosure provides methods for the UE to provide information to the gNB to achieve 5GS clock synchronization of desired accuracy.

According to certain embodiments, a method by a terminal device includes transmitting information about a first preference of the terminal device to use a TA based propagation delay estimation or a RRT based propagation delay estimation.

According to certain embodiments, a terminal device is adapted to transmit information about a first preference of the terminal device to use a TA based propagation delay estimation or a RRT based propagation delay estimation.

According to certain embodiments, a method by a network node receiving, from a terminal device, information about a first preference of the terminal device to use a TA based propagation delay estimation or a RRT based propagation delay estimation.

According to certain embodiments, a network node is adapted to receive, from a terminal device, information about a first preference of the terminal device to use a TA based propagation delay estimation or a RRT based propagation delay estimation.

Certain embodiments of the present disclosure may provide one or more technical advantages. For example, certain embodiments may provide methods relating to how a UE can assist the gNB to achieve adequate clock synchronization between gNB and UE, while keeping the implementation complexity reasonable for gNB and UE.

Other advantages may be readily apparent to one having skill in the art. Certain embodiments may have none, some, or all of the recited advantages.

### BRIEF DESCRIPTION OF THE DRAWINGS

The present disclosure may be best understood by way of example with reference to the following description and accompanying drawings that are used to illustrate embodiments of the present disclosure. In the drawings:

FIG. 1 is a diagram illustrating TSN end-to-end timing delivery;

FIG. 2 is a sequence diagram illustrating transmission between the UE and the network node;

FIG. 3 is a flow chart illustrating a method implemented on a terminal device, according to some embodiments of the present disclosure;

FIG. 4 is a flow chart a method implemented on a network node, according to some embodiments of the present disclosure;

FIG. 5 is a block diagram illustrating a terminal device, according to some embodiments of the present disclosure;

FIG. 6 is another block diagram illustrating a terminal device, according to some embodiments of the present disclosure;

FIG. 7 is a block diagram illustrating a network node according to some embodiments of the present disclosure;

FIG. 8 is another block diagram illustrating a network node according to some embodiments of the present disclosure;

FIG. 9 is a block diagram illustrating a wireless communication system according to some embodiments of the present disclosure;

FIG. 10 is a block diagram schematically illustrating a telecommunication network connected via an intermediate network to a host computer;

FIG. 11 is a generalized block diagram of a host computer communicating via a base station with a user equipment over a partially wireless connection;

FIGS. 12 to 15 are flowcharts illustrating methods implemented in a communication system including a host computer, a base station and a user equipment; and

FIG. 16 is a flowchart illustrating a method by a terminal device, according to certain embodiments; and

FIG. 17 is a flowchart illustrating a method by a network node, according to certain embodiments.

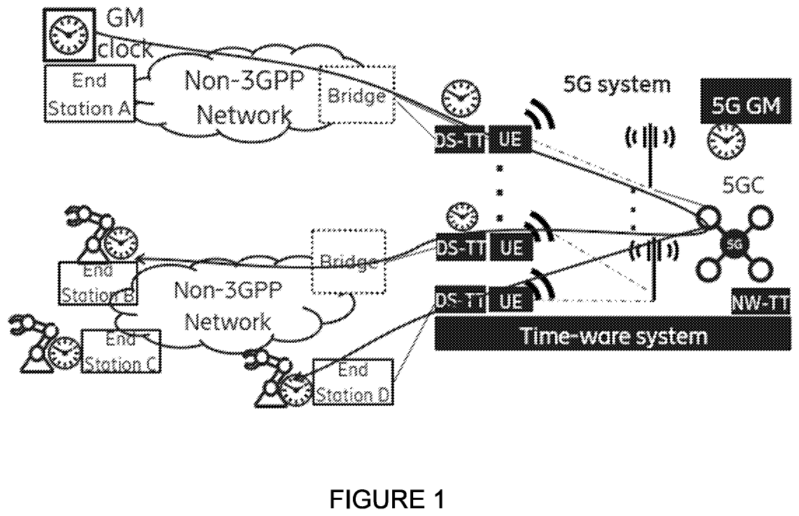

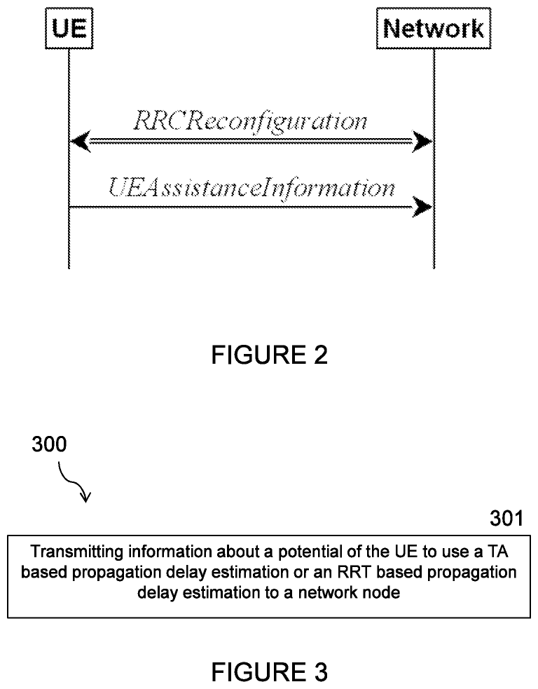

### DETAILED DESCRIPTION

The following detailed description describes methods and devices for time synchronization in a TSN. In the following detailed description, numerous specific details such as logic implementations, types and interrelationships of system components, etc. are set forth in order to provide a more thorough understanding of the present disclosure. It should be appreciated, however, by one skilled in the art that the present disclosure may be practiced without such specific details. In other instances, control structures, circuits and instruction sequences have not been shown in detail in order not to obscure the present disclosure. Those of ordinary skill in the art, with the included descriptions, will be able to implement appropriate functionality without undue experimentation.

References in the specification to “one embodiment”, “an embodiment”, “an example embodiment” etc. indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Bracketed text and blocks with dashed borders (e.g., large dashes, small dashes, dot-dash, and dots) may be used herein to illustrate optional operations that add additional features to embodiments of the present disclosure. However, such notation should not be taken to mean that these are the only options or optional operations, and/or that blocks with solid borders are not optional in certain embodiments of the present disclosure.

In the following detailed description and claims, the terms “coupled” and “connected,” along with their derivatives, may be used. It should be understood that these terms are not intended as synonyms for each other. “Coupled” is used to indicate that two or more elements, which may or may not be in direct physical or electrical contact with each other, cooperate or interact with each other. “Connected” is used to indicate the establishment of communication between two or more elements that are coupled with each other.

An electronic device stores and transmits (internally and/or with other electronic devices over a network) code (which is composed of software instructions and which is sometimes referred to as computer program code or a computer program) and/or data using machine-readable media (also called computer-readable media), such as machine-readable storage media (e.g., magnetic disks, optical disks, read only memory (ROM), flash memory devices, phase change memory) and machine-readable transmission media (also called a carrier) (e.g., electrical, optical, radio, acoustical or other forms of propagated signals—such as carrier waves, infrared signals). Thus, an electronic device (e.g., a computer) includes hardware and software, such as a set of one or more processors coupled to one or more machine-readable storage media to store code for execution on the set of processors and/or to store data. For instance, an electronic device may include non-volatile memory containing the code since the non-volatile memory can persist code/data even when the electronic device is turned off (when power is removed), and while the electronic device is turned on, that part of the code that is to be executed by the processor(s) of that electronic device is typically copied from the slower non-volatile memory into volatile memory (e.g., dynamic random access memory (DRAM), static random access memory (SRAM)) of that electronic device. Typical electronic devices also include a set of one or more physical network interfaces to establish network connections (to transmit and/or receive code and/or data using propagating signals) with other electronic devices. One or more parts of an embodiment of the present disclosure may be implemented using different combinations of software, firmware, and/or hardware.

The present disclosure provides methods for the UE to provide information to the gNB to achieve 5GS clock synchronization of desired accuracy. In order to achieve 5GS time synchronization, it is demanding on both UEs and network nodes. Thus, the design for time synchronization at the air interface should satisfy the need of achieving the accuracy requirement, while keeping complexity and power consumption low for both UE and gNB. UE assistance information may be used to achieve the best results.

According to certain embodiments, for example, assistance information may be indicated by the UE to the network node and may include one or more of the following:
Which node is responsible for time adjustment, i.e., either network-based adjustment or terminal-based adjustment;
The method to perform propagation delay estimation, for example, TA based method or RTT based method;
Ways to indicate/determine the time synchronization methods;
The clock synchronization accuracy to be achieved at the Uu interface;
The exact refresh moment of the reference time;
The preference in how the time is provided, i.e., broadcast or unicast;
The refresh periodicity to maintain clock synchronization between gNB and UE;
TSN and non-TSN UE differentiation.

The exemplary application is that the 5G system can support a TSN as a TSN bridge.

According to certain embodiments, a method implemented by a terminal device is provided. The method comprises: transmitting information about a potential of the terminal device to use a timing advance, TA, based propagation delay estimation or a round-trip time, RRT, based propagation delay estimation to a network node.

In a particular embodiment, the potential may be a preference of the terminal device to use the TA based or RRT based estimation.

In another particular embodiment, the potential may be a capability of the terminal device to use the TA based or RRT based estimation.

According to certain embodiments, a terminal device is provided. The terminal device is adapted to perform the methods described herein.

According to certain embodiments, a method implemented by a network node is provided. The method comprises: determining whether the network node needs a potential of a terminal device to use a propagation delay estimation; and in the case that the network node needs the potential to use the propagation delay estimation, receiving, from the terminal device, information about the potential of the terminal device to use a timing advance, TA, based propagation delay estimation or a round-trip time, RRT, based propagation delay estimation.

According to certain embodiments, a network node is provided. The network node comprises a processor and a memory communicatively coupled to the processor. The memory is adapted to store instructions which, when executed by the processor, cause the network node to perform operations of the methods described herein.

According to certain embodiments, a network node is provided. The network node is adapted to perform the methods described herein.

### Propagation Delay Preference in UE Assistance Information

According to certain embodiments, the UE signals to the gNB its preference to use TA-based propagation delay estimation method or RTT-based propagation delay estimation method. By signaling the preferred method, the UE also indicates its preference for the signals/channels and procedures that goes along with the desired method. In particular embodiments, the signals/channels include downlink reference signals and related configuration, uplink reference signal and related configuration, PRACH transmission on the uplink, PDCCH (physical downlink control channel) for triggering a downlink or uplink transmission, etc. The procedure includes higher layer procedures such as RRC procedure and MAC procedure, as well as physical layer procedure.

In a particular embodiment, the UE may signal its preference to use a network-based (e.g., the gNB performs the estimation of propagation delay and sends the timing adjustment info to the UE) method or a terminal-based method (e.g., the UE performs the estimation and compensation of propagation delay).

With the gNB based time adjustment, the gNB is the entity to figure out the time an individual UE should assume (e.g., by estimating the propagation delay a particular UE experiences between the UE and the gNB), and the UE does not need to perform propagation delay estimation, although the UE may perform certain actions to support the gNB. In particular embodiments, the actions the UE perform may include transmitting an uplink signal with desired characteristics (e.g., with wider bandwidth, and/or with repetitions in time) so that the gNB can estimate the uplink signal arrival time more accurately.

In contrast, with the UE based method, the UE is the entity to figure out the time the UE should assume (e.g., by estimating the propagation delay the UE itself experiences between the UE and the gNB). The gNB does not perform propagation delay estimation for an individual UE, although the gNB may perform certain actions to support the UE. In particular embodiments, the action the gNB performs may include sending, to the UE, a signal containing timing information for deriving propagation delay. The signal containing timing information may be: (a) a timing advance command; (b) an absolute timing advance command; and/or (c) a timing delta command.

In another particular embodiment, the UE signals its preference to use a network-based compensation method or a terminal-based compensation method. This can be transmitted in conjunction with the preference of the estimation method, such as TA-based or RTT-based.

For example, in a particular embodiment, if the UE signals its preference to use TA-based estimation with network-based compensation, the estimation method is done by the TA-based methods while the propagation delay compensation is done by the network. In a particular embodiment, for example, a field is added in the reference time delivery IE to indicate that the propagation delay has been compensated or the UE can deliver the received time directly to the upper layer. An example with the added field name preCompensated-r17 is shown below:

| DLInformationTransfer-v1610-IEs ::= SEQUENCE { | |
|---|---|
| referenceTimeInfo-r16 | ReferenceTimeInfo-r16 |
| OPTIONAL | |
| nonCriticalExtension | DLInformationTransfer- |
| v17xy-IEs OPTIONAL | |
| } | |
| DLInformationTransfer-v17xy-IEs ::= SEQUENCE { | |
| preCompensated-r17 | ENUMERATE{true} |
| OPTIONAL | |
| nonCriticalExtension | SEQUENCE{ } |

OPTIONAL
}

In another particular embodiment, if the UE signals its preference to use TA-based estimation with UE-based compensation, the estimation method is done by the TA-based methods while the propagation delay compensation is done by the UE. For example, the above-described field is not set to be true in this scenario. In this case, the network transmits the timing adjustment information (such as TA MAC CE) to the UE, and the UE compensates the time with the propagation delay before the UE delivers the time to the upper layer.

In yet another particular embodiment, if the UE signals its preference to use RTT-based estimation with network-based compensation, the estimation method is done by the RTT-based methods while the propagation delay compensation is done by the network. In this scenario, a field is added in the reference time delivery IE to indicate that the propagation delay has been compensated or the UE can deliver the received time directly to the upper layer. The above-described example with the field name preCompensated-r17 applies here as well. Additionally, the UE may need to transmit any RTT measurements (e.g., UE Rx-TX time difference) to the network.

In still another particular embodiment, if the UE signals its preference to use RTT-based estimation with UE-based compensation, the estimation method is done by the RTT-based methods while the propagation delay compensation is done by the UE. In this scenario, the above-described field is not set to be true. Additionally, the network may need to transmit any RTT measurements (e.g., gNB Rx-TX time difference) to the UE.

In another particular embodiment, the UE signals its desired clock synchronization accuracy. In a preferred embodiment, the accuracy is for the Uu interface (i.e., between the gNB and the UE). Alternatively or additionally, the accuracy may refer to the end-to-end synchronization requirement. The accuracy may depend on the number of Uu interface traversed from ingress to egress in 5GS (5G system), and also the number of network nodes traversed. The UE may have knowledge of its end-to-end accuracy requirement of a UE.

In another particular embodiment, the UE signals its desired periodicity to refresh the clock between UE and network. The refresh periodicity may depend on the UE clock drift in the UE implementation. For instance, if the UE can maintain its clock with little drift, refresh periodicity can be longer. Otherwise, the UE needs a shorter refresh periodicity. The refresh periodicity defines the time duration the UE and gNB can wait to perform next round of clock synchronization after performing one around of clock synchronization between gNB and UE.

In another particular embodiment, the UE signals its desired refresh moment with respect to a known reference system. For example, the UE and the network may use the reference System Frame Number (SFN) as a reference. The UE can indicate that it prefers that the next refresh happens at the reference SFN=x, or the UE can indicate that it prefers that the next reference time refresh indicates the time at the reference SFN=y. The UE may use the received reference time on the Uu interface to time stamp the user plane data that contains general Precision Time Protocol (gPTP) sync packets and the UE indicates the refresh moment as close as possible to the arrival of such user plane data. This may alleviate any UE clock drift inaccuracy, since the UE may use its internal oscillator to track the reference time in-between two reference time refresh from the network, and the UE clock drift inaccuracy deteriorates over time.

In another particular embodiment, the UE may signal its preference in how the reference time is provided, either in a broadcast message (i.e., SIB9) or an RRC-dedicated unicast message (i.e., DLInformationTransfer). In some cases, the UE hardware implementation may be different in terms of processing the system information and of processing the dedicated and unicast RRC message. For example, the UE can maintain a better time tracking if the reference time is provided in the SIB9.

The below is an exemplary implementation in the RRC specification to capture the some of the above-mentioned methods. Other methods can be implemented similarly by adding relevant fields in the IE PropagationDelayPreference-r17.

UEAssistanceInformation-v17xy-IEs ::= SEQUENCE {
propagationDelayPreference-r17

| | |
|---|---|
| PropagationDelayPreference-r17 | OPTIONAL, |
| nonCriticalExtension | SEQUENCE { } |

```
  OPTIONAL
}
PropagationDelayPreference-r17 ::= SEQUENCE {
  timeAdjustment ENUMERATED {netowrkBased, terminalBased},
  estimationMethod ENUMERATED {TA, RTT}
  accuracy ENUMERATED {ns10, ns20, ns50, ns100, ns200,
ns500, ns800 },
  refreshPeriodicity ENUMERATED {ms200, ms500, ms1000, ms2000}
}
```

### Triggering Conditions

In a particular embodiment, the UE signals its preference only if configured by the network. Additionally or alternatively, in a particular embodiment, the UE signals its preference if a triggering condition such as, for example, any one of the below described trigger conditions, is satisfied.

For example, in a particular embodiment, the UE signals its preference if the UE has not transmitted any preference since it was configured by the network.

As another example, in a particular embodiment, the UE signals its preference if the UE's preference changed from the last time the UE initiated transmission of UEAssistanceInformation that includes propagationDelayPreference. For example, in one scenario, if the UE indicated in a previous message that it prefers to be “terminal based”, but due to the expectation that the UE is going to be in a high mobility scenario the UE now has a power consumption issue, the UE may signal its preference. As another example, the UE may signal its preference if the downlink channel conditions are bad or going to be bad because, in this scenario, the UE may that network perform the estimation and the compensation of the propagation delay. On the other hand, the UE can indicate the preference that the estimation and the compensation is performed at the UE if the UE is in a stationary condition and/or the UE side estimation/compensation may provide a more accurate propagation delay estimation/compensation.

As still another example, in a particular embodiment, the UE signals its preference if the UE's preference is not the same as what the network has configured for the propagation delay estimation/compensation. For example, the UE may prefer the network to estimate and compensate, but the network may ask UE to perform estimation and compensation.

Which triggering conditions are to be used can either be a fixed combination or can be configured by the network in a RRC message. For example, the UE may signal its preference when the UE has not transmitted any preference since it was configured by the network and the UE's preference is not the same as what the network has configured for the propagation delay estimation/compensation. As another example, the UE may signal its preference when the UE has not transmitted any preference since it was configured by the network and the UE's preference changed from the last time the UE initiated transmission of UEAssistanceInformation that includes propagationDelayPreference. As still another example, the network node may configure the UE to signal its preference when the UE has not transmitted any preference since it was configured by the network and the UE's preference is not the same as what the network has configured for the propagation delay estimation/compensation.

According to certain embodiments, UE may start a prohibit timer (i.e., propagationDelayPreferenceTimer) once a UE preference was triggered and sent on a UEAssistanceInformation message. If the timer is running, UE cannot trigger the transmission of the preference. This is to prevent excessive indication of the UE preference by the UE and leaves sufficient time for the network node to react based on the UE preference.

An example of the spec impact in 3GPP TR 38.331 is shown below. The configuration by the network to provide the preference is in the IE OtherConfig and the changes related with triggering conditions are in the subclause of 5.7.4.2.

The IE OtherConfig contains configuration related to miscellaneous other configurations:

OtherConfig information element

| | |
|---|---|
| OtherConfig-v17xy ::= | SEQUENCE { |
| propDelayAssistanceConfig-r17 | SetupRelease |
| {PropDelayAssistanceConfig-r17} | OPTIONAL, -- |

Need M
}

| | |
|---|---|
| PropDelayAssistanceConfig-r17 ::= | SEQUENCE { |
| propagationDelayPreferenceTimer1 | ENUMERATED { |
| | s0, s0dot5, s1, s2, s3, |

s4, s5, s6, s7,

s8, s9, s10, s20, s30,

infinity, spare1},

| | |
|---|---|
| propagationDelayPreferenceTimer2 | ENUMERATED { |
| | s0, s0dot5, s1, s2, s3, |

s4, s5, s6, s7,

s8, s9, s10, s20, s30,

infinity, spare1},
}

### Initiation

1> if configured to provide preference in propagatationDelayPreference
   2> if the UE did not transmit a UEAssistanceInformation message with propagationDelayPreference since it was configured to provide preference; or
   2> if the UE's preference changed from the last time UE initiated transmission of the UEAssistanceInformation message including propagationDelayPreference and the timer propagationDelayPreferenceTimer1 is not running:
      3> initiate transmission of the UEAssistanceInformation message in accordance with 5.7.4.3 to provide preference in propagatationDelayPreference.
      3> start the timer propagationDelayPreferenceTimer2
   2> if the UE's preference in propagationDelayPreference is different from the configuration in how the propagation delay is compensated and the timer propagationDelayPreferenceTimer2 is not running:
      3> initiate transmission of the UEAssistanceInformation message in accordance with 5.7.4.3 to provide preference in propagatationDelayPreference.
   3> start the timer propagationDelayEstPreferenceTimer2

### Other Implicit Preference Indications

The propagation delay estimation aspects described above can be part of UE capability signalling as well. That is, instead of indicating UE's preference, the UE signals to gNB what it's capable of, in particular embodiments. Based on UE's signalled capability, the gNB can select the proper configuration for clock synchronization between gNB and UE.

In a particular embodiment, for example, the UE signals its capability to support network-based (i.e., gNB performs the estimation of propagation delay and sends the timing adjustment info to UE) method, or terminal-based method (i.e., UE performs the estimation of propagation delay), or both.

In another particular embodiment, for example, the UE signals to gNB its capability to support a TA-based propagation delay estimation method or a RTT-based propagation delay estimation method or both.

In another particular embodiment, the UE signals the one or more levels of clock synchronization accuracy it can support.

In one example embodiment, the UE capability/preference is implicitly indicated to gNB based on the selected PRACH resource. In a sub-embodiment of this embodiment, the PRACH resource can be one or more of the following: a PRACH time/frequency resource, a PRACH preambles, a PRACH sequence length, a PRACH format, a PRACH power ramping step, a PRACH back off time configuration, and the set of SSBs associated to the PRACH occasion and PRACH preambles.

### gNB Configuration and Network Node Methods

Each network node may make the decision as to whether the particular network node needs UE preference on the propagation delay compensation. For example, the network node may not support the network-based estimation/compensation.

In a particular embodiment, the gNB differentiates the TSN UE and the non-TSN UE based on the reported capability or the reported UE preferences transmitted in the UEAssistanceInformation message. Afterwards, the network configures correspondingly, e.g., the propagation delay methods to be used, the bandwidth of the reference signals, the type of the reference signals, and etc. Here, TSN UE is used to represent UEs that need accurate clock synchronization with network, whereas non-TSN UE is used to represent UEs that do not need accurate clock synchronization with network.

Alternatively or additionally, the gNB may receive TSN traffic information from another network node, which assists the gNB with properly configuring the methods, signaling, and procedure for propagation delay estimation for a given UE. In a preferred example, the gNB receives information from another network node about TSN traffic periodicity, and the gNB ensures that clock synchronization procedure is performed (if necessary) to ensure accurate timing before TSN message arrival. In another example, the source gNB forwards the RRC message UEAssistanceInformation to the target gNB during the handover procedure or the handover preparation procedure (e.g., the conditional handover related procedures).

In another example, for a UE that is configured to transmit assistance information on propagation delay compensation, i.e., propDelayAssistanceConfig, the UE keeps (by default) this configuration. In other words, if the UE initiates a RRC connection reestablishment procedure or a RRC resume procedure, the UE considers it has been configured with propDelayAssistanceConfig even if it reestablishes/resumes to a different network node from the network node which initially configured propDelayAssistanceConfig.

In a particular embodiment, when the UE initiates a RRC connection reestablishment procedure or when the UE initiates a RRC resume procedure, the configuration related with assistance information on propagation delay compensation is released by the UE. An example of the spec impact in 3GPP TR 38.331 is shown below with changes underlined:
**** Irrelevant parts omitted *****
Upon initiation of the procedure, the UE shall:
   **** Irrelevant parts omitted *****
   1> if UE is not configured with conditionalReconfiguration:
      **** Irrelevant parts omitted *****
      2> release PropDelavAssistanceConfig, if configured.
      2> stop the timer propagationDelavEstPreferenceTimer1, if running
      2> stop the timer propagationDelavEstPreferenceTimer2, if running
   **** Irrelevant parts omitted *****
   1> release PropDelayAssistanceConfig from the UE Inactive AS context, if stored.
   1> stop the timer propagationDelayEstPreferenceTimer1, if running
   1> stop the timer propagationDelayEstPreferenceTimer2, if running
**** Irrelevant parts omitted *****

FIG. 3 illustrates a method 300 implemented on a terminal device, according to certain embodiments. As an example, operations of this flow chart may be performed by a UE, but they are not limited thereto. The operations in this and other flow charts may be described with reference to the exemplary embodiments of the other figures. However, it should be appreciated that the operations of the flow charts may be performed by embodiments of the present disclosure other than those discussed with reference to the other figures, and the embodiments of the present disclosure discussed with reference to these other figures may perform operations different than those discussed with reference to the flow charts.

In the illustrated embodiment, the UE transmits information about a potential of the UE to use a TA based propagation delay estimation or an RRT based propagation delay estimation to a network node, at step 301.

As an example, in a particular embodiment, the potential may be a preference of the UE to use the TA based or RRT based estimation.

As a further example, in a particular embodiment, the preference comprises a preference of the UE for signals, channels and/or procedures for the propagation delay estimation.

As a further example, in a particular embodiment, the signals may include at least downlink reference signals and uplink reference signals, the channels may include at least a PRACH transmission on the uplink and a PDCCH for triggering a downlink or uplink transmission, and/or the procedures may include at least a higher layer procedure and a physical layer procedure.

As an example, in a particular embodiment, the potential may be a capability of the UE to use the TA based or RRT based estimation.

As an example, in a particular embodiment, the information may be further associated with a potential of the UE to use a network node based propagation delay estimation or a UE based propagation delay estimation.

As a further example, in a particular embodiment, the method 300 may further include, in the case of the network node based propagation delay estimation, transmitting an uplink signal with desired characteristics to the network node.

As a further example, in a particular embodiment, the desired characteristics may include a wider bandwidth and/or repetitions in time.

As a further example, in a particular embodiment, the method 300 may further include, in the case that the UE based propagation delay estimation, receiving a signal containing timing information for deriving propagation delay from the network node.

As a further example, in a particular embodiment, the signal containing the timing information may include one of: a TA command; an absolute TA command; and a timing delta command.

As an example, in a particular embodiment, the method 300 may further include transmitting information about a potential of the UE to use a network node based compensation or a UE based compensation to the network node.

As a further example, in a particular embodiment, the information about the potential to use the compensation may be transmitted along with the information about the potential to use the propagation delay estimation.

As a further example, in a particular embodiment, a field may be added to a reference time delivery information element to indicate that the propagation delay has been compensated or the UE is able to deliver received time directly to an upper layer.

As a further example, in the case of the network node based compensation, the field may be set to be true, and in the case of the UE based compensation, the field may be set to be false and the method 300 may further comprise: compensating the time with the propagation delay; and transmitting the time to the upper layer.

As a further example, in the case of the RTT based estimation and the network node based compensation, the method 300 may further comprise transmitting RTT measurements to the network node, and in the case of the RTT based estimation and the UE based compensation, the method 300 may further comprise receiving RTT measurements from the network node.

As an example, in a particular embodiment, the method 300 may further include transmitting a desired clock synchronization accuracy of the UE to the network node.

As a further example, in a particular embodiment, the desired clock synchronization accuracy may be associated with a Uu interface between the network node and the UE.

As a further example, in a particular embodiment, the desired clock synchronization accuracy may be associated with an end-to-end synchronization requirement.

As a further example, in a particular embodiment, the desired clock synchronization accuracy may depend on the number of Uu interfaces traversed from an ingress to an egress in a 5^{th} generation system, 5GS, and on the number of network nodes traversed.

As an example, in a particular embodiment, the method 300 may further include transmitting, to the network node, a desired periodicity of the UE to refresh a clock between the UE and the network node.

As a further example, in a particular embodiment, the refresh periodicity may depend on a UE clock drift.

As an example, in a particular embodiment, the method 300 may further include transmitting a desired refresh moment with respect to a predetermined reference system to the network node.

As a further example, in a particular embodiment, the reference system may be a reference system frame number, SFN.

As a further example, in a particular embodiment, the desired refresh moment may be determined by: timestamping user plane data which contains sync packets using received reference time on the Uu interface; and indicating a refresh moment as close as possible to arrival of the user plane data as the desired refresh moment.

As an example, in a particular embodiment, the method 300 may further include transmitting a preference of the UE in whether reference time is provided in a broadcast message or an RRC dedicated unicast message to the network node.

As an example, in a particular embodiment, the information about the potential may be transmitted only in response to configuration of the network node.

As an example, in a particular embodiment, the information about the potential may be transmitted in at least one of the following cases: the UE has not transmitted any information about the potential after configuration of the network node; the potential of the UE has changed from the last time the UE initiated transmission of information about a potential for the propagation delay; and the potential of the UE is not the same as that configured by the network node.

As a further example, in a particular embodiment, a combination of the cases may be a predetermined combination or a combination configured by the network node in an RRC message.

As a further example, in a particular embodiment, the method 300 may further include, in the case that the potential of the UE has changed or the potential of the UE is not the same as that configured by the network node, starting a prohibit timer once a potential is triggered and transmitted to the network node.

As a further example, in a particular embodiment, in the case that the prohibit timer is running, the UE may not be allowed to trigger the transmission of the potential.

As an example, in a particular embodiment, the information about the potential of the UE may be transmitted based on a selected PRACH resource.

As a further example, in a particular embodiment, the PRACH resource may be at least one of: a PRACH time/frequency resource, PRACH preambles, a PRACH sequence length, a PRACH format, a PRACH power ramping step, PRACH back off time configuration, and a set of single side bands, SSBs, associated with a PRACH occasion and the PRACH preambles.

As an example, in a particular embodiment, the method 300 may further includes, upon initiation of an RRC connection reestablishment procedure or an RRC resume procedure, keeping or releasing configuration associated with propagation delay assistance.

As a further example, the method 300 may further include, in the case the configuration associated with the propagation delay assistance is released, stopping timers for potentials for propagation delay estimation.

As an example, in a particular embodiment, the network node may be a gNB, a base station or an access point.

Furthermore, the present disclosure provides a terminal device which is adapted to perform the method 300.

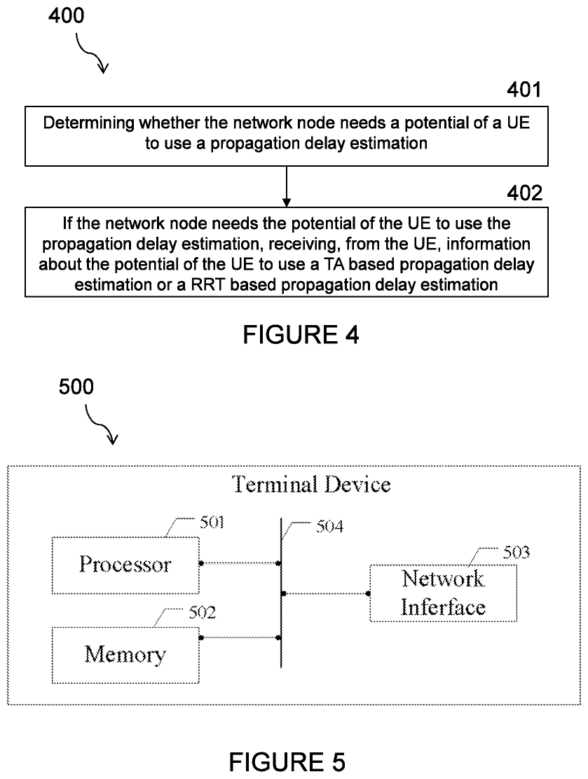

FIG. 4 illustrates a method 400 implemented on a network node, according to certain embodiments. At step 401, the network node determines whether the network node needs a potential of a UE to use a propagation delay estimation. In the case that the network node needs the potential to use the propagation delay estimation, the network node receives, from the UE, information about the potential of the UE to use a TA based propagation delay estimation or an RRT based propagation delay estimation, at step 402.

As an example, in a particular embodiment, the potential may be a preference of the UE to use the TA based or RRT based estimation.

As a further example, in a particular embodiment, the preference may comprise a preference of the UE for signals, channels and/or procedures for the propagation delay estimation.

As a further example, in a particular embodiment, the signals may include at least downlink reference signals and uplink reference signals, the channels may include at least a PRACH transmission on the uplink and a PDCCH for triggering a downlink or uplink transmission, and the procedures may include at least a higher layer procedure and a physical layer procedure.

As an example, in a particular embodiment, the potential may be a capability of the UE to use the TA based or RRT based estimation.

As a further example, in a particular embodiment, the method 400 may further include selecting configuration for clock synchronization between the network node and the UE based on the capability of the UE.

As an example, in a particular embodiment, the information may be further associated with a potential of the UE to use a network node based propagation delay estimation or a UE based propagation delay estimation.

As a further example, in a particular embodiment, the method 400 may further include, in the case of the network node based propagation delay estimation, receiving an uplink signal with desired characteristics from the UE.

As a further example, in a particular embodiment, the desired characteristics may include a wider bandwidth and/or repetitions in time.

As a further example, in a particular embodiment, the method 400 may further include, in the case that the UE based propagation delay estimation, transmitting a signal containing timing information for deriving propagation delay to the UE.

As a further example, in a particular embodiment, the signal containing the timing information may include one of: a TA command; an absolute TA command; and a timing delta command.

As an example, in a particular embodiment, the method 400 may further include determining whether the network node needs a potential of the UE to use a propagation delay compensation and, in the case that the network node needs the potential to use the propagation delay compensation, receiving information about the potential of the UE to use a network node based compensation or a UE based compensation from the UE.

As a further example, in a particular embodiment, the information about the potential to use the compensation may be received along with the information about the potential to use the propagation delay estimation.

As a further example, in a particular embodiment, in the case of the RTT based estimation and the network node based compensation, the method 400 may further include receiving RTT measurements from the UE and, in the case of the RTT based estimation and the UE based compensation, the method 400 may further include transmitting RTT measurements to the UE.

As an example, in a particular embodiment, the method 400 may further include receiving a desired clock synchronization accuracy of the UE from the UE.

As a further example, in a particular embodiment, the desired clock synchronization accuracy may be associated with a Uu interface between the network node and the UE.

As a further example, in a particular embodiment, the desired clock synchronization accuracy may be associated with an end-to-end synchronization requirement.

As a further example, in a particular embodiment, the desired clock synchronization accuracy may depend on the number of Uu interfaces traversed from an ingress to an egress in a 5^{th} generation system, 5GS, and on the number of network nodes traversed.

As an example, in a particular embodiment, the method 400 may further include receiving, from the UE, a desired periodicity of the UE to refresh a clock between the UE and the network node.

As a further example, in a particular embodiment, the refresh periodicity may depend on a UE clock drift.

As an example, in a particular embodiment, the method 400 may further include receiving a desired refresh moment with respect to a predetermined reference system from the UE.

As a further example, in a particular embodiment, the reference system may be a reference SFN.

As an example, in a particular embodiment, the method 400 may further include receiving a preference of the UE in whether reference time is provided in a broadcast message or a radio resource control, RRC, dedicated unicast message from the UE.

As an example, in a particular embodiment, the information about the potential of the UE may be received based on a selected PRACH resource.

As a further example, in a particular embodiment, the PRACH resource may be at least one of: a PRACH time/frequency resource, PRACH preambles, a PRACH sequence length, a PRACH format, a PRACH power ramping step, PRACH back off time configuration, and a set of single side bands, SSBs, associated with a PRACH occasion and the PRACH preambles.

As an example, in a particular embodiment, the method 400 may further include differentiating a TSN UE from a non-TSN UE based on the information about the potential of the UE.

As a further example, in a particular embodiment, the method 400 may further include configuring propagation delay approaches to be used, bandwidths of reference signals and types of the reference signals based on the TSN UE or the non-TSN UE.

As an example, in a particular embodiment, the method 400 may further include receiving TSN traffic information from another network node which assists the network node for configuration of the propagation delay estimation.

As an example, in a particular embodiment, the method 400 may further include receiving information about a TSN traffic periodicity from another network node.

As an example, in a particular embodiment, the method 400 may further include forwarding an RRC message about UE assistance to another network node during a handover procedure or a handover preparation procedure.

As an example, in a particular embodiment, the network node may be a gNB, a base station or an access point.

Furthermore, the present disclosure provides a network node which is adapted to perform the method 400.

FIG. 5 illustrates a terminal device 500, according to certain embodiments. As an example, the terminal device 500 may act as the UE, but it is not limited thereto. It should be appreciated that the terminal device 500 may be implemented using components other than those illustrated in FIG. 5.

With reference to FIG. 5, the terminal device 500 may comprise at least a processor 501, a memory 502, a network interface 503 and a communication medium 504. The processor 501, the memory 502 and the network interface 503 may be communicatively coupled to each other via the communication medium 504.

The processor 501 may include one or more processing units. A processing unit may be a physical device or article of manufacture comprising one or more integrated circuits that read data and instructions from computer readable media, such as the memory 502, and selectively execute the instructions. In various embodiments, the processor 501 may be implemented in various ways. As an example, the processor 501 may be implemented as one or more processing cores. As another example, the processor 501 may comprise one or more separate microprocessors. In yet another example, the processor 501 may comprise an application-specific integrated circuit (ASIC) that provides specific functionality. In still another example, the processor 501 may provide specific functionality by using an ASIC and/or by executing computer-executable instructions.

The memory 502 may include one or more computer-usable or computer-readable storage medium capable of storing data and/or computer-executable instructions. It should be appreciated that the storage medium is preferably a non-transitory storage medium.

The network interface 503 may be a device or article of manufacture that enables the terminal device 500 to send data to or receive data from other devices. In different embodiments, the network interface 503 may be implemented in different ways. As an example, the network interface 503 may be implemented as an Ethernet interface, a token-ring network interface, a fiber optic network interface, a network interface (e.g., Wi-Fi, WiMax, etc.), or another type of network interface.

The communication medium 504 may facilitate communication among the processor 501, the memory 502 and the network interface 503. The communication medium 504 may be implemented in various ways. For example, the communication medium 504 may comprise a Peripheral Component Interconnect (PCI) bus, a PCI Express bus, an accelerated graphics port (AGP) bus, a serial Advanced Technology Attachment (ATA) interconnect, a parallel ATA interconnect, a Fiber Channel interconnect, a USB bus, a Small Computing System Interface (SCSI) interface, or another type of communications medium.

In the example of FIG. 5, the instructions stored in the memory 502 may include those that, when executed by the processor 501, cause the terminal device 500 to implement the method described with respect to FIG. 3.

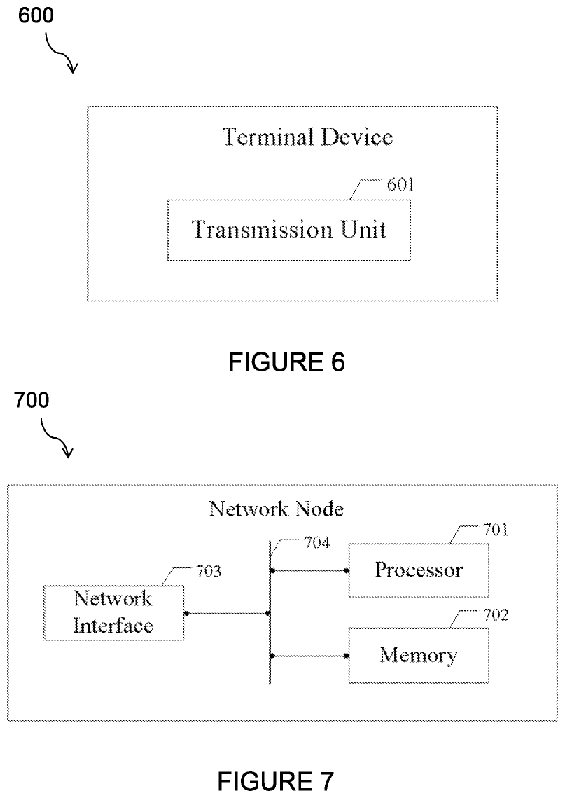

FIG. 6 illustrates a terminal device 600, according to certain embodiments. As an example, the terminal device 600 may act as the UE, but it is not limited thereto. It should be appreciated that the terminal device 600 may be implemented using components other than those illustrated in FIG. 6.

With reference to FIG. 6, the terminal device 600 may comprise at least a transmission unit 601. The transmission unit 601 may be adapted to perform at least the operation described in the block 301 of FIG. 3.

FIG. 7 illustrates a network node 700, according to certain embodiments. As an example, the network node 700 may act as the network node, but it is not limited thereto. It should be appreciated that the network node 700 may be implemented using components other than those illustrated in FIG. 7.

With reference to FIG. 7, the network node 700 may comprise at least a processor 701, a memory 702, a network interface 703 and a communication medium 704. The processor 701, the memory 702 and the network interface 703 are communicatively coupled to each other via the communication medium 704.

The processor 701, the memory 702, the network interface 703 and the communication medium 704 are structurally similar to the processor 501, the memory 502, the network interface 503 and the communication medium 504 respectively, and will not be described herein in detail.

In the example of FIG. 7, the instructions stored in the memory 702 may include those that, when executed by the processor 701, cause the network node 700 to implement the method described with respect to FIG. 4.

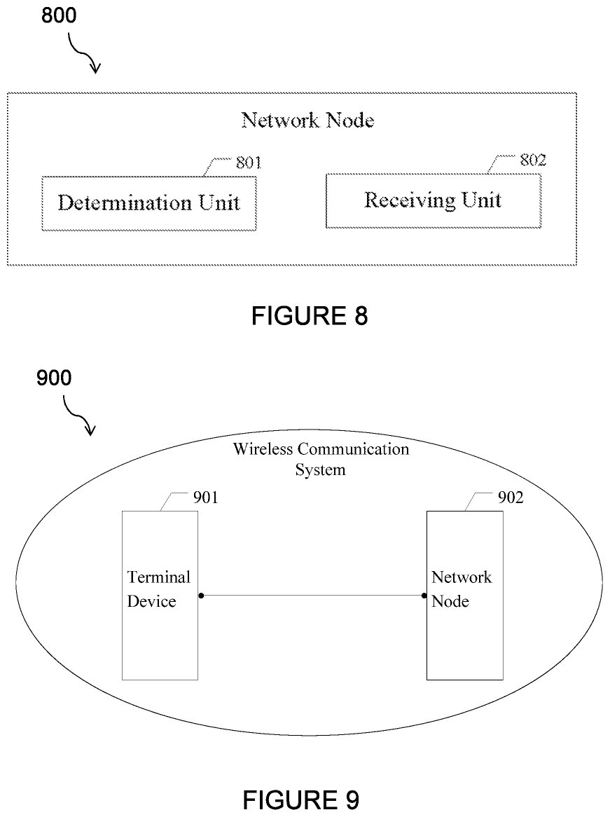

FIG. 8 is another block diagram illustrating a network node 800 according to some embodiments of the present disclosure. As an example, the network node 800 may provide act as the network node, but it is not limited thereto. It should be appreciated that the network node 800 may be implemented using components other than those illustrated in FIG. 8.

With reference to FIG. 8, the network node 800 may comprise at least a determination unit 801 and a receiving unit 802. The determination unit 801 may be adapted to perform at least the operation described in the block 401 of FIG. 4. The receiving unit 802 may be adapted to perform at least the operation described in the block 402 of FIG. 4.

The units shown in FIGS. 6 and 8 may constitute machine-executable instructions embodied within a machine, e.g., readable medium, which when executed by a machine will cause the machine to perform the operations described. Besides, any of these units may be implemented as hardware, such as an application specific integrated circuit (ASIC), Digital Signal Processor (DSP), Field Programmable Gate Array (FPGA) or the like.

Moreover, it should be appreciated that the arrangements described herein are set forth only as examples. Other arrangements (e.g., more controllers or more detectors, etc.) may be used in addition to or instead of those shown, and some units may be omitted altogether. Functionality and cooperation of these units are correspondingly described in more detail with reference to FIGS. 3 and 4.

FIG. 9 illustrates a wireless communication system 900, according to certain embodiments. The wireless communication system 900 comprises at least a terminal device 901 and a network node 902. In one embodiment, the terminal device 901 may act as the terminal device 500 or 600 as depicted in FIG. 5 or 6, and the network node 902 may act as the network node 700 or 800 as depicted in FIG. 7 or 8. In one embodiment, the terminal device 901 and the network node 902 may communicate with each other.

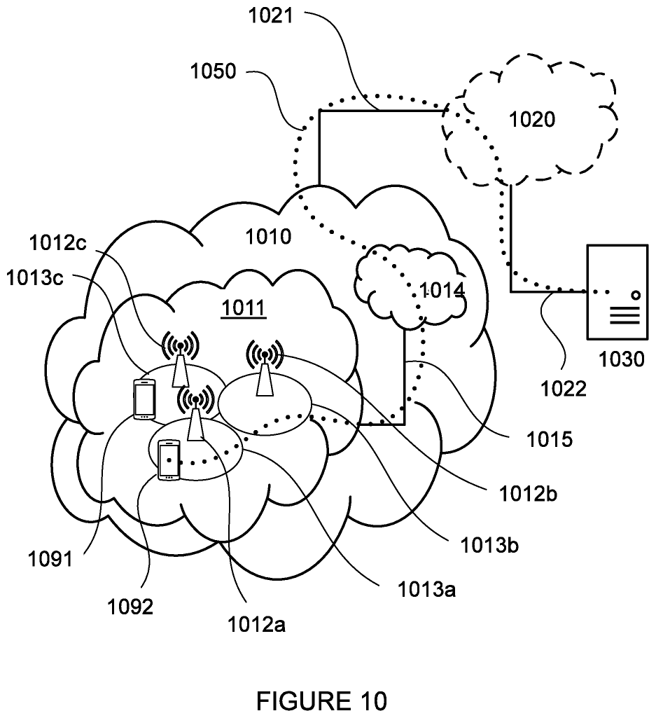

FIG. 10 illustrates a telecommunication network connected via an intermediate network to a host computer.

With reference to FIG. 10, in accordance with an embodiment, a communication system includes a telecommunication network 1010, such as a 3GPP-type cellular network, which comprises an access network 1011, such as a radio access network, and a core network 1014. The access network 1011 comprises a plurality of base stations 1012a, 1012b, 1012c, such as NBs, eNBs, gNBs or other types of wireless access points, each defining a corresponding coverage area 1013a, 1013b, 1013c. Each base station 1012a, 1012b, 1012c is connectable to the core network 1014 over a wired or wireless connection 1015. A first UE 1091 located in coverage area 1013c is configured to wirelessly connect to, or be paged by, the corresponding base station 1012c. A second UE 1092 in coverage area 1013a is wirelessly connectable to the corresponding base station 1012a. While a plurality of UEs 1091, 1092 are illustrated in this example, the disclosed embodiments are equally applicable to a situation where a sole UE is in the coverage area or where a sole UE is connecting to the corresponding base station 1012.

The telecommunication network 1010 is itself connected to a host computer 1030, which may be embodied in the hardware and/or software of a standalone server, a cloud-implemented server, a distributed server or as processing resources in a server farm. The host computer 1030 may be under the ownership or control of a service provider, or may be operated by the service provider or on behalf of the service provider. The connections 1021, 1022 between the telecommunication network 1010 and the host computer 1030 may extend directly from the core network 1014 to the host computer 1030 or may go via an optional intermediate network 1020. The intermediate network 1020 may be one of, or a combination of more than one of, a public, private or hosted network; the intermediate network 1020, if any, may be a backbone network or the Internet; in particular, the intermediate network 1020 may comprise two or more sub-networks (not shown).

The communication system of FIG. 10 as a whole enables connectivity between one of the connected UEs 1091, 1092 and the host computer 1030. The connectivity may be described as an over-the-top (OTT) connection 1050. The host computer 1030 and the connected UEs 1091, 1092 are configured to communicate data and/or signaling via the OTT connection 1050, using the access network 1011, the core network 1014, any intermediate network 1020 and possible further infrastructure (not shown) as intermediaries. The OTT connection 1050 may be transparent in the sense that the participating communication devices through which the OTT connection 1050 passes are unaware of routing of uplink and downlink communications. For example, a base station 1012 may not or need not be informed about the past routing of an incoming downlink communication with data originating from a host computer 1030 to be forwarded (e.g., handed over) to a connected UE 1091. Similarly, the base station 1012 need not be aware of the future routing of an outgoing uplink communication originating from the UE 1091 towards the host computer 1030.

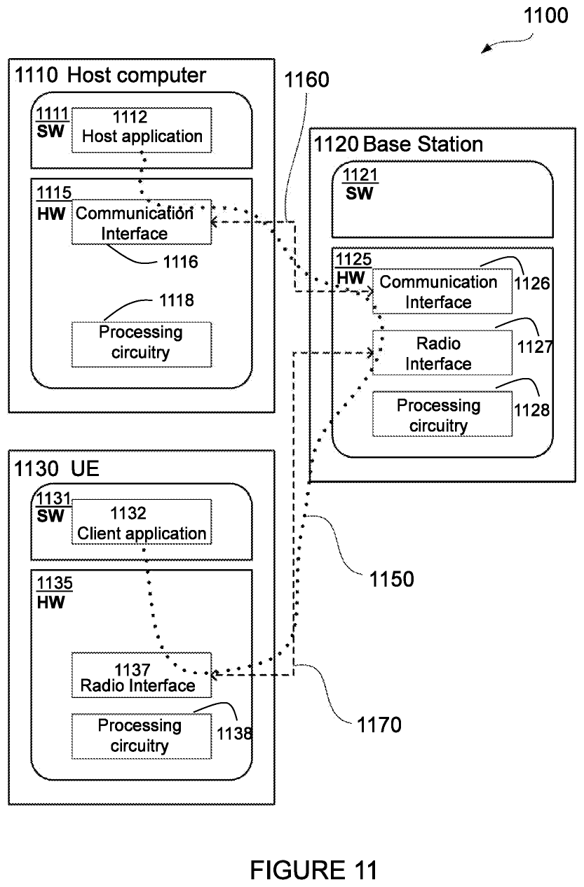

Example implementations, in accordance with an embodiment, of the UE, base station and host computer discussed in the preceding paragraphs will now be described with reference to FIG. 11. In a communication system 1100, a host computer 1110 comprises hardware 1115 including a communication interface 1116 configured to set up and maintain a wired or wireless connection with an interface of a different communication device of the communication system 1100. The host computer 1110 further comprises processing circuitry 1118, which may have storage and/or processing capabilities. In particular, the processing circuitry 1118 may comprise one or more programmable processors, application-specific integrated circuits, field programmable gate arrays or combinations of these (not shown) adapted to execute instructions. The host computer 1110 further comprises software 1111, which is stored in or accessible by the host computer 1110 and executable by the processing circuitry 1118. The software 1111 includes a host application 1112. The host application 1112 may be operable to provide a service to a remote user, such as a UE 1130 connecting via an OTT connection 1150 terminating at the UE 1130 and the host computer 1110. In providing the service to the remote user, the host application 1112 may provide user data which is transmitted using the OTT connection 1150.

The communication system 1100 further includes a base station 1120 provided in a telecommunication system and comprising hardware 1125 enabling it to communicate with the host computer 1110 and with the UE 1130. The hardware 1125 may include a communication interface 1126 for setting up and maintaining a wired or wireless connection with an interface of a different communication device of the communication system 1100, as well as a radio interface 1127 for setting up and maintaining at least a wireless connection 1170 with a UE 1130 located in a coverage area (not shown in FIG. 11) served by the base station 1120. The communication interface 1126 may be configured to facilitate a connection 1160 to the host computer 1110. The connection 1160 may be direct or it may pass through a core network (not shown in FIG. 11) of the telecommunication system and/or through one or more intermediate networks outside the telecommunication system. In the embodiment shown, the hardware 1125 of the base station 1120 further includes processing circuitry 1128, which may comprise one or more programmable processors, application-specific integrated circuits, field programmable gate arrays or combinations of these (not shown) adapted to execute instructions. The base station 1120 further has software 1121 stored internally or accessible via an external connection.

The communication system 1100 further includes the UE 1130 already referred to. Its hardware 1135 may include a radio interface 1137 configured to set up and maintain a wireless connection 1170 with a base station serving a coverage area in which the UE 1130 is currently located. The hardware 1135 of the UE 1130 further includes processing circuitry 1138, which may comprise one or more programmable processors, application-specific integrated circuits, field programmable gate arrays or combinations of these (not shown) adapted to execute instructions. The UE 1130 further comprises software 1131, which is stored in or accessible by the UE 1130 and executable by the processing circuitry 1138. The software 1131 includes a client application 1132. The client application 1132 may be operable to provide a service to a human or non-human user via the UE 1130, with the support of the host computer 1110. In the host computer 1110, an executing host application 1112 may communicate with the executing client application 1132 via the OTT connection 1150 terminating at the UE 1130 and the host computer 1110. In providing the service to the user, the client application 1132 may receive request data from the host application 1112 and provide user data in response to the request data. The OTT connection 1150 may transfer both the request data and the user data. The client application 1132 may interact with the user to generate the user data that it provides.

It is noted that the host computer 1110, base station 1120 and UE 1130 illustrated in FIG. 11 may be identical to the host computer 1030, one of the base stations 1012a, 1012b, 1012c and one of the UEs 1091, 1092 of FIG. 10, respectively. This is to say, the inner workings of these entities may be as shown in FIG. 11 and independently, the surrounding network topology may be that of FIG. 10.

In FIG. 11, the OTT connection 1150 has been drawn abstractly to illustrate the communication between the host computer 1110 and the use equipment 1130 via the base station 1120, without explicit reference to any intermediary devices and the precise routing of messages via these devices. Network infrastructure may determine the routing, which it may be configured to hide from the UE 1130 or from the service provider operating the host computer 1110, or both. While the OTT connection 1150 is active, the network infrastructure may further take decisions by which it dynamically changes the routing (e.g., on the basis of load balancing consideration or reconfiguration of the network).

The wireless connection 1170 between the UE 1130 and the base station 1120 is in accordance with the teachings of the embodiments described throughout this disclosure. One or more of the various embodiments improve the performance of OTT services provided to the UE 1130 using the OTT connection 1150, in which the wireless connection 1170 forms the last segment. More precisely, the teachings of these embodiments may improve the radio resource utilization and thereby provide benefits such as reduced user waiting time.

A measurement procedure may be provided for the purpose of monitoring data rate, latency and other factors on which the one or more embodiments improve. There may further be an optional network functionality for reconfiguring the OTT connection 1150 between the host computer 1110 and UE 1130, in response to variations in the measurement results. The measurement procedure and/or the network functionality for reconfiguring the OTT connection 1150 may be implemented in the software 1111 of the host computer 1110 or in the software 1131 of the UE 1130, or both. In embodiments, sensors (not shown) may be deployed in or in association with communication devices through which the OTT connection 1150 passes; the sensors may participate in the measurement procedure by supplying values of the monitored quantities exemplified above, or supplying values of other physical quantities from which software 1111, 1131 may compute or estimate the monitored quantities. The reconfiguring of the OTT connection 1150 may include message format, retransmission settings, preferred routing etc.; the reconfiguring need not affect the base station 1120, and it may be unknown or imperceptible to the base station 1120. Such procedures and functionalities may be known and practiced in the art. In certain embodiments, measurements may involve proprietary UE signaling facilitating the host computer's 1110 measurements of throughput, propagation times, latency and the like. The measurements may be implemented in that the software 1111, 1131 causes messages to be transmitted, in particular empty or ‘dummy’ messages, using the OTT connection 1150 while it monitors propagation times, errors etc.

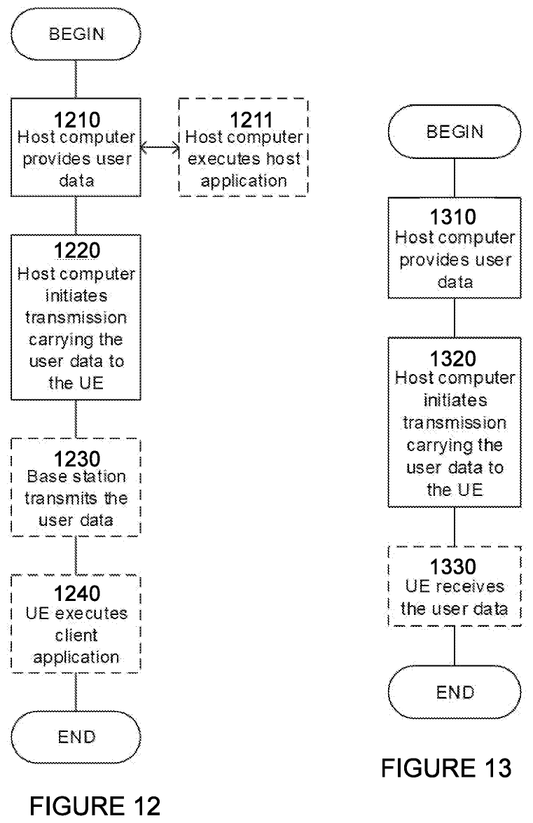

FIG. 12 illustrates a method implemented in a communication system, in accordance with one embodiment. The communication system includes a host computer, a base station and a UE which may be those described with reference to FIGS. 10 and 11. For simplicity of the present disclosure, only drawing references to FIG. 12 will be included in this section. In a first step 1210 of the method, the host computer provides user data. In an optional substep 1211 of the first step 1210, the host computer provides the user data by executing a host application. In a second step 1220, the host computer initiates a transmission carrying the user data to the UE. In an optional third step 1230, the base station transmits to the UE the user data which was carried in the transmission that the host computer initiated, in accordance with the teachings of the embodiments described throughout this disclosure. In an optional fourth step 1240, the UE executes a client application associated with the host application executed by the host computer.

FIG. 13 illustrates a method implemented in a communication system, in accordance with one embodiment. The communication system includes a host computer, a base station and a UE which may be those described with reference to FIGS. 10 and 11. For simplicity of the present disclosure, only drawing references to FIG. 13 will be included in this section. In a first step 1310 of the method, the host computer provides user data. In an optional substep (not shown) the host computer provides the user data by executing a host application. In a second step 1320, the host computer initiates a transmission carrying the user data to the UE. The transmission may pass via the base station, in accordance with the teachings of the embodiments described throughout this disclosure. In an optional third step 1330, the UE receives the user data carried in the transmission.

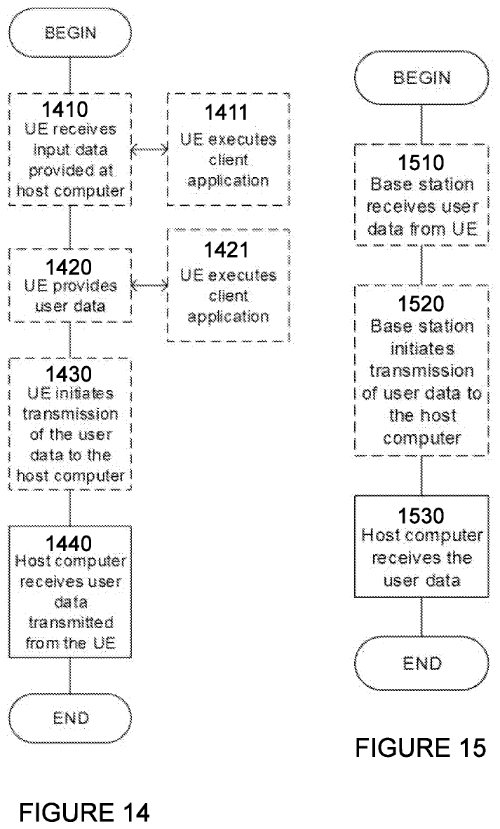

FIG. 14 illustrates a method implemented in a communication system, in accordance with one embodiment. The communication system includes a host computer, a base station and a UE which may be those described with reference to FIGS. 10 and 11. For simplicity of the present disclosure, only drawing references to FIG. 14 will be included in this section. In an optional first step 1410 of the method, the UE receives input data provided by the host computer. Additionally or alternatively, in an optional second step 1420, the UE provides user data. In an optional substep 1421 of the second step 1420, the UE provides the user data by executing a client application. In a further optional substep 1411 of the first step 1410, the UE executes a client application which provides the user data in reaction to the received input data provided by the host computer. In providing the user data, the executed client application may further consider user input received from the user. Regardless of the specific manner in which the user data was provided, the UE initiates, in an optional third substep 1430, transmission of the user data to the host computer. In a fourth step 1440 of the method, the host computer receives the user data transmitted from the UE, in accordance with the teachings of the embodiments described throughout this disclosure.

FIG. 15 illustrates a method implemented in a communication system, in accordance with one embodiment. The communication system includes a host computer, a base station and a UE which may be those described with reference to FIGS. 10 and 11. For simplicity of the present disclosure, only drawing references to FIG. 15 will be included in this section. In an optional first step 1510 of the method, in accordance with the teachings of the embodiments described throughout this disclosure, the base station receives user data from the UE. In an optional second step 1520, the base station initiates transmission of the received user data to the host computer. In a third step 1530, the host computer receives the user data carried in the transmission initiated by the base station.

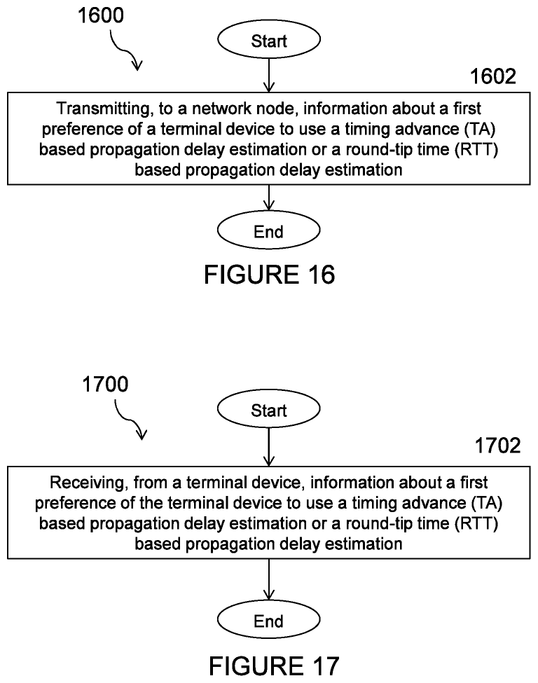

FIG. 16 illustrates a method 1600 by a terminal device 600 such as, for example, a UE, according to certain embodiments. The method includes, at step 1602, transmitting, to a network node 700, information about a first preference of the terminal device 600 to use a TA based propagation delay estimation or a RRT based propagation delay estimation.

In a particular embodiment, the first preference comprises at least one of: a preference of the terminal device for at least one downlink reference signal; a preference of the terminal device for at least one uplink reference signal; and a preference of the terminal device for at least one PRACH transmission on an uplink.

In a particular embodiment, the first preference indicates a preference of the terminal device 600 to use a network node based propagation delay estimation or a terminal device based propagation delay estimation.

In a particular embodiment, when the preference of the terminal device 600 is to use network based propagation delay estimation, the method further includes transmitting an uplink signal with at least one characteristic to the network node 700. The at least one characteristic includes a number of repetitions in time.

In a particular embodiment, the method includes transmitting, to the network node 700, information about a second preference of the terminal device 600 to use a network node based compensation or a terminal device based compensation to the network node 700.

In a particular embodiment, the information about the second preference of the terminal device 600 is transmitted with the information about the first preference of the terminal device 600.

In a particular embodiment, a field is added to a reference time delivery information element to indicate that a propagation delay has been compensated.

In a particular embodiment, the terminal device 600 transmits, to the network node 700, a desired clock synchronization accuracy of the terminal device.

In a particular embodiment, the first preference includes a periodicity for refreshing a clock between the terminal device 600 and the network node 700.

In a particular embodiment, the first preference comprises a refresh moment with respect to a predetermined reference system to the network node 700.

In a particular embodiment, the predetermined reference system comprises a reference SFN.

In a particular embodiment, the refresh moment is determined by indicating the refresh moment that is as close as possible to the received reference time on the Uu interface.

In a particular embodiment, the information about the first preference is transmitted in response to at least one of: determining that the terminal device 600 has not transmitted any information about the first preference after configuration of the terminal device 600 by the network node 700; determining that the first preference of the terminal device 600 has changed from a last time the terminal device initiated transmission of information about the propagation delay; and determining that the first preference of the terminal device 600 is not the same as that configured by the network node 700.

In a particular embodiment, when the terminal device 600 determines that the first preference has changed or the that the first preference is not the same as that configured by the network node 700. The method includes starting a prohibit timer when the first preference is transmitted to the network node 700.

In a particular embodiment, the information about the first preference of the terminal device 600 is transmitted based on a selected PRACH resource, and the PRACH resource is at least one of: a PRACH time/frequency resource, a PRACH preamble, a PRACH sequence length, a PRACH format, a PRACH power ramping step, PRACH back off time configuration, and a set of single side bands, SSBs, associated with a PRACH occasion and the PRACH preamble.

In a particular embodiment, upon initiation of an RRC connection reestablishment procedure or an RRC resume procedure, the terminal device 600 keeps or releases a configuration comprising at least one triggering condition for transmitting the first preference.

In a particular embodiment, in response to releasing the configuration, the terminal device 600 stops at least one timer for the first preference for propagation delay estimation.

FIG. 17 illustrates a method 1700 by a network node 700, according to certain embodiments. The method includes receiving, from a terminal device 600, information about a first preference of the terminal device to use a TA based propagation delay estimation or a RRT based propagation delay estimation, at step 1702.

In a particular embodiment, the network node 700 selects a configuration for clock synchronization between the network node 700 and the terminal device 600 based on the information about the first preference of the terminal device 600.

In a particular embodiment, based on the information about the first preference of the terminal device 600, the network node 700 determines whether the terminal device 600 is a TSN terminal device or a non-TSN terminal device. The network node 700 determines or adjusts at least one parameter associated with a propagation delay configuration based on whether the terminal device 600 is determined to be the TSN terminal device or the non-TSN terminal device.

In a particular embodiment, the network node 700 determines whether the network node 700 needs the information about the first preference of the terminal device 600 and transmits, to the terminal device 600, a request for the information about the first preference.

In a particular embodiment, the first preference comprises at least one of: a preference of the terminal device for at least one downlink reference signal; a preference of the terminal device for at least one uplink reference signal; and a preference of the terminal device for at least one PRACH transmission on an uplink.

In a particular embodiment, the first preference indicate a preference of the terminal device to use a network node based propagation delay estimation or a terminal device based propagation delay estimation.

In a particular embodiment, when the preference of the terminal device 600 is to use the network based propagation delay estimation, the network node 700 receives an uplink signal with at least one characteristics from the terminal device 600. The at least one characteristic comprises a number of repetitions in time.

In a particular embodiment, when the preference of the terminal device 600 is to use the terminal device based propagation delay estimation, the network node 700 transmits, to the terminal device 600, a signal containing timing information for deriving the terminal device based propagation delay estimation. The timing information includes at least one of: a TA command; an absolute TA command; and a timing delta command.

In a particular embodiment, the network node 700 receives, from the terminal device 600, information about a second preference of the terminal device 600 to use a network node based compensation or a terminal device based compensation from the terminal device.

In a particular embodiment, the information about the second preference of the terminal device 600 is received with the information about the first preference of the terminal device 600.

In a particular embodiments, a field is added to a reference time delivery information element to indicate that ta propagation delay has been compensated.

In a particular embodiments, the information about the first preference indicates that the terminal device 600 uses the RTT based propagation delay estimation and the information about the second preference indicates that the terminal device 600 uses the network node based compensation, and the network node 700 receives at least one RTT measurement from the terminal device 600 or the information about the first preference indicates that the terminal devices 600 uses the RTT based propagation delay estimation and the information about the second preference indicates that the terminal device 600 uses the terminal device based compensation, and the method further comprises transmitting at least one RTT measurement to the terminal device 600.

In a particular embodiment, the network node 700 receives, from the terminal device 600, a desired clock synchronization accuracy of the terminal device 600.

In a particular embodiments, the first preference comprises a periodicity for refreshing a clock between the terminal device 600 and the network node 700.

In a particular embodiments, the first preference comprises a refresh moment with respect to a predetermined reference system.

In a particular embodiments, the reference system is a reference SFN.

In a particular embodiment, the information about the first preference of the terminal device is received based on a selected PRACH resource, and wherein the PRACH resource is at least one of: a PRACH time/frequency resource, a PRACH preamble, a PRACH sequence length, a PRACH format, a PRACH power ramping step, a PRACH back off time configuration, and a set of single side bands, SSBs, associated with a PRACH occasion and the PRACH preamble.

In a particular embodiment, the network node 700 receives TSN traffic information from another network node. Based on the TSN traffic information received from the other network node, the network node 700 determines or adjusts a configuration for the propagation delay estimation.

In a particular embodiment, the TSN traffic information comprises a TSN traffic.

In a particular embodiment, the network node 700 transmits, to at least one other network node, a RRC message comprising terminal device assistance during a handover procedure or a handover preparation procedure.

Some portions of the foregoing detailed description have been presented in terms of algorithms and symbolic representations of transactions on data bits within a computer memory. These algorithmic descriptions and representations are ways used by those skilled in the data processing arts to most effectively convey the substance of their work to others skilled in the art. An algorithm is here, and generally, conceived to be a self-consistent sequence of transactions leading to a desired result. The transactions are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be appreciated, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “processing” or “computing” or “calculating” or “determining” or “displaying” or the like, refer to actions and processes of a computer system, or a similar electronic computing device, that manipulates and transforms data represented as physical (electronic) quantities within the computer system's registers and memories into other data similarly represented as physical quantities within the computer system memories or registers or other such information storage, transmission or display devices.

The algorithms and displays presented herein are not inherently related to any particular computer or other apparatus. Various general-purpose systems may be used with programs in accordance with the teachings herein, or it may prove convenient to construct more specialized apparatus to perform the required method transactions. The required structure for a variety of these systems will appear from the description above. In addition, embodiments of the present disclosure are not described with reference to any particular programming language. It should be appreciated that a variety of programming languages may be used to implement the teachings of embodiments of the present disclosure as described herein.

An embodiment of the present disclosure may be an article of manufacture in which a non-transitory machine-readable medium (such as microelectronic memory) has stored thereon instructions (e.g., computer code) which program one or more data processing components (generically referred to here as a “processor”) to perform the operations described above. In other embodiments, some of these operations might be performed by specific hardware components that contain hardwired logic (e.g., dedicated digital filter blocks and state machines). Those operations might alternatively be performed by any combination of programmed data processing components and fixed hardwired circuit components.

In the foregoing detailed description, embodiments of the present disclosure have been described with reference to specific exemplary embodiments thereof. It will be evident that various modifications may be made thereto without departing from the spirit and scope of the present disclosure as set forth in the following claims. The specification and drawings are, accordingly, to be regarded in an illustrative sense rather than a restrictive sense.

Throughout the description, some embodiments of the present disclosure have been presented through flow diagrams. It should be appreciated that the order of transactions and transactions described in these flow diagrams are only intended for illustrative purposes and not intended as a limitation of the present disclosure. One having ordinary skill in the art would recognize that variations can be made to the flow diagrams without departing from the spirit and scope of the present disclosure as set forth in the following claims.

### EXAMPLE EMBODIMENTS

Example Embodiment 1. A method (300) implemented by a terminal device, the method comprising: transmitting (301) information about a potential of the terminal device to use a timing advance, TA, based propagation delay estimation or a round-trip time, RRT, based propagation delay estimation to a network node.

Example Embodiment 2. The method of Example Embodiment 1, wherein the potential is a preference of the terminal device to use the TA based or RRT based estimation.

Example Embodiment 3. The method of Example Embodiment 2, wherein the preference comprises a preference of the terminal device for signals, channels and/or procedures for the propagation delay estimation.

Example Embodiment 4. The method of Example Embodiment 3, wherein the signals include at least downlink reference signals and uplink reference signals, wherein the channels include at least a physical random access channel, PRACH, transmission on the uplink and a physical downlink control channel, PDCCH for triggering a downlink or uplink transmission, and wherein the procedures include at least a higher layer procedure and a physical layer procedure.

Example Embodiment 5. The method of Example Embodiment 1, wherein the potential is a capability of the terminal device to use the TA based or RRT based estimation.

Example Embodiment 6. The method of any of Example Embodiments 1-5, wherein the information is further associated with a potential of the terminal device to use a network node based propagation delay estimation or a terminal device based propagation delay estimation.

Example Embodiment 7. The method of Example Embodiment 6, further comprising: in the case of the network node based propagation delay estimation, transmitting an uplink signal with desired characteristics to the network node.

Example Embodiment 8. The method of Example Embodiment 7, wherein the desired characteristics include a wider bandwidth and/or repetitions in time.

Example Embodiment 9. The method of Example Embodiment 6, further comprising: in the case that the terminal device based propagation delay estimation, receiving a signal containing timing information for deriving propagation delay from the network node.

Example Embodiment 10. The method of Example Embodiment 9, wherein the signal containing the timing information includes one of: a TA command; an absolute TA command; and a timing delta command.

Example Embodiment 11. The method of any of Example Embodiments 1-10, further comprising: transmitting information about a potential of the terminal device to use a network node based compensation or a terminal device based compensation to the network node.

Example Embodiment 12. The method of Example Embodiment 11, wherein the information about the potential to use the compensation is transmitted along with the information about the potential to use the propagation delay estimation.

Example Embodiment 13. The method of Example Embodiment 11 or 12, wherein a field is added to a reference time delivery information element to indicate that the propagation delay has been compensated or the terminal device is able to deliver received time directly to an upper layer.

Example Embodiment 14. The method of Example Embodiment 13, wherein in the case of the network node based compensation, the field is set to be true, and wherein in the case of the terminal device based compensation, the field is set to be false and the method further comprises: compensating the time with the propagation delay; and transmitting the time to the upper layer.

Example Embodiment 15. The method of any of Example Embodiments 11-14, wherein in the case of the RTT based estimation and the network node based compensation, the method further comprises transmitting RTT measurements to the network node, and wherein in the case of the RTT based estimation and the terminal device based compensation, the method further comprises receiving RTT measurements from the network node.

Example Embodiment 16. The method of any of Example Embodiments 1-15, further comprising: transmitting a desired clock synchronization accuracy of the terminal device to the network node.

Example Embodiment 17. The method of Example Embodiment 16, wherein the desired clock synchronization accuracy is associated with a Uu interface between the network node and the terminal device.

Example Embodiment 18. The method of Example Embodiment 16 or 17, wherein the desired clock synchronization accuracy is associated with an end-to-end synchronization requirement.

Example Embodiment 19. The method of any of Example Embodiments 16-18, wherein the desired clock synchronization accuracy depends on the number of Uu interfaces traversed from an ingress to an egress in a 5^{th} generation system, 5GS, and on the number of network nodes traversed.

Example Embodiment 20. The method of any of Example Embodiments 1-19, further comprising: transmitting, to the network node, a desired periodicity of the terminal device to refresh a clock between the terminal device and the network node.

Example Embodiment 21. The method of Example Embodiment 20, wherein the refresh periodicity depends on a terminal device clock drift.

Example Embodiment 22. The method of any of Example Embodiments 1-21, further comprising: transmitting a desired refresh moment with respect to a predetermined reference system to the network node.

Example Embodiment 23. The method of Example Embodiment 22, wherein the reference system is a reference single frequency network, SFN.

Example Embodiment 24. The method of Example Embodiment 22 or 23, wherein the desired refresh moment is determined by: timestamping user plane data which contains sync packets using received reference time on the Uu interface; and indicating a refresh moment as close as possible to arrival of the user plane data as the desired refresh moment.

Example Embodiment 25. The method of any of Example Embodiments 1-24, further comprising: transmitting a preference of the terminal device in whether reference time is provided in a broadcast message or a radio resource control, RRC, dedicated unicast message to the network node.

Example Embodiment 26. The method of any of Example Embodiments 1-25, wherein the information about the potential is transmitted only in response to configuration of the network node.

Example Embodiment 27. The method of any of Example Embodiments 1-25, wherein the information about the potential is transmitted in at least one of the following cases: the terminal device has not transmitted any information about the potential after configuration of the network node; the potential of the terminal device has changed from the last time the terminal device initiated transmission of information about a potential for the propagation delay; and the potential of the terminal device is not the same as that configured by the network node.

Example Embodiment 28. The method of Example Embodiment 27, wherein a combination of the cases is a predetermined combination or a combination configured by the network node in an RRC message.

Example Embodiment 29. The method of Example Embodiment 27 or 28, further comprising: in the case that the potential of the terminal device has changed or the potential of the terminal device is not the same as that configured by the network node, starting a prohibit timer once a potential is triggered and transmitted to the network node.

Example Embodiment 30. The method of Example Embodiment 29, wherein in the case that the prohibit timer is running, the terminal device is not allowed to trigger the transmission of the potential.

Example Embodiment 31. The method of any of Example Embodiments 1-30, wherein the information about the potential of the terminal device is transmitted based on a selected PRACH resource.

Example Embodiment 32. The method of Example Embodiment 31, wherein the PRACH resource is at least one of: a PRACH time/frequency resource, PRACH preambles, a PRACH sequence length, a PRACH format, a PRACH power ramping step, PRACH back off time configuration, and a set of single side bands, SSBs, associated with a PRACH occasion and the PRACH preambles.

Example Embodiment 33. The method of any of Example Embodiments 1-32, further comprising: upon initiation of an RRC connection reestablishment procedure or an RRC resume procedure, keeping or releasing configuration associated with propagation delay assistance.

Example Embodiment 34. The method of Example Embodiment 33, further comprising: in the case the configuration associated with the propagation delay assistance is released, stopping timers for potentials for propagation delay estimation.

Example Embodiment 35. The method of any of Example Embodiments 1-34, wherein the network node is a gNB, a base station or an access point.

Example Embodiment 36. A method (400) implemented by a network node, the method comprising: determining (401) whether the network node needs a potential of a terminal device to use a propagation delay estimation; and in the case that the network node needs the potential to use the propagation delay estimation, receiving (402), from the terminal device, information about the potential of the terminal device to use a timing advance, TA, based propagation delay estimation or a round-trip time, RRT, based propagation delay estimation.

Example Embodiment 37. The method of Example Embodiment 36, wherein the potential is a preference of the terminal device to use the TA based or RRT based estimation.

Example Embodiment 38. The method of Example Embodiment 37, wherein the preference comprises a preference of the terminal device for signals, channels and/or procedures for the propagation delay estimation.

Example Embodiment 39. The method of Example Embodiment 38, wherein the signals include at least downlink reference signals and uplink reference signals, wherein the channels include at least a physical random access channel, PRACH, transmission on the uplink and a physical downlink control channel, PDCCH for triggering a downlink or uplink transmission, and wherein the procedures include at least a higher layer procedure and a physical layer procedure.

Example Embodiment 40. The method of Example Embodiment 36, wherein the potential is a capability of the terminal device to use the TA based or RRT based estimation.

Example Embodiment 41. The method of Example Embodiment 40, further comprising: selecting configuration for clock synchronization between the network node and the terminal device based on the capability of the terminal device.

Example Embodiment 42. The method of any of Example Embodiments 36-41, wherein the information is further associated with a potential of the terminal device to use a network node based propagation delay estimation or a terminal device based propagation delay estimation.

Example Embodiment 43. The method of Example Embodiment 42, further comprising: in the case of the network node based propagation delay estimation, receiving an uplink signal with desired characteristics from the terminal device.

Example Embodiment 44. The method of Example Embodiment 43, wherein the desired characteristics include a wider bandwidth and/or repetitions in time.

Example Embodiment 45. The method of Example Embodiment 42, further comprising: in the case that the terminal device based propagation delay estimation, transmitting a signal containing timing information for deriving propagation delay to the terminal device.

Example Embodiment 46. The method of Example Embodiment 45, wherein the signal containing the timing information includes one of: a TA command; an absolute TA command; and a timing delta command.

Example Embodiment 47. The method of any of Example Embodiments 36-46, further comprising: determining whether the network node needs a potential of the terminal device to use a propagation delay compensation; and in the case that the network node needs the potential to use the propagation delay compensation, receiving information about the potential of the terminal device to use a network node based compensation or a terminal device based compensation from the terminal device.

Example Embodiment 48. The method of Example Embodiment 47, wherein the information about the potential to use the compensation is received along with the information about the potential to use the propagation delay estimation.

Example Embodiment 49. The method of Example Embodiment 47 or 48, wherein in the case of the RTT based estimation and the network node based compensation, the method further comprises receiving RTT measurements from the terminal device, and wherein in the case of the RTT based estimation and the terminal device based compensation, the method further comprises transmitting RTT measurements to the terminal device.

Example Embodiment 50. The method of any of Example Embodiments 36-49, further comprising: receiving a desired clock synchronization accuracy of the terminal device from the terminal device.

Example Embodiment 51. The method of Example Embodiment 50, wherein the desired clock synchronization accuracy is associated with a Uu interface between the network node and the terminal device.

Example Embodiment 52. The method of Example Embodiment 50 or 51, wherein the desired clock synchronization accuracy is associated with an end-to-end synchronization requirement.

Example Embodiment 53. The method of any of Example Embodiments 50-52, wherein the desired clock synchronization accuracy depends on the number of Uu interfaces traversed from an ingress to an egress in a 5^{th} generation system, 5GS, and on the number of network nodes traversed.

Example Embodiment 54. The method of any of Example Embodiments 36-53, further comprising: receiving, from the terminal device, a desired periodicity of the terminal device to refresh a clock between the terminal device and the network node.

Example Embodiment 55. The method of Example Embodiment 54, wherein the refresh periodicity depends on a terminal device clock drift.

Example Embodiment 56. The method of any of Example Embodiments 36-55, further comprising: receiving a desired refresh moment with respect to a predetermined reference system from the terminal device.

Example Embodiment 57. The method of Example Embodiment 56, wherein the reference system is a reference single frequency network, SFN.

Example Embodiment 58. The method of any of Example Embodiments 36-57, further comprising: receiving a preference of the terminal device in whether reference time is provided in a broadcast message or a radio resource control, RRC, dedicated unicast message from the terminal device.

Example Embodiment 59. The method of any of Example Embodiments 36-58, wherein the information about the potential of the terminal device is received based on a selected PRACH resource.

Example Embodiment 60. The method of Example Embodiment 59, wherein the PRACH resource is at least one of: a PRACH time/frequency resource, PRACH preambles, a PRACH sequence length, a PRACH format, a PRACH power ramping step, PRACH back off time configuration, and a set of single side bands, SSBs, associated with a PRACH occasion and the PRACH preambles.

Example Embodiment 61. The method of any of Example Embodiments 36-60, further comprising: differentiating a time sensitive network, TSN, terminal device from a non-TSN terminal device based on the information about the potential of the terminal device.

Example Embodiment 62. The method of Example Embodiment 61, further comprising: configuring propagation delay approaches to be used, bandwidths of reference signals and types of the reference signals based on the TSN terminal device or the non-TSN terminal device.

Example Embodiment 63. The method of any of Example Embodiments 36-62, further comprising: receiving TSN traffic information from another network node which assists the network node for configuration of the propagation delay estimation.

Example Embodiment 64. The method of any of Example Embodiments 36-63, further comprising: receiving information about a TSN traffic periodicity from another network node.

Example Embodiment 65. The method of any of Example Embodiments 36-64, further comprising: forwarding an RRC message about terminal device assistance to another network node during a handover procedure or a handover preparation procedure.

Example Embodiment 66. The method of any of Example Embodiments 36-65, wherein the network node is a gNB, a base station or an access point.

Example Embodiment 67. A terminal device (500), comprising: a processor (501); and a memory (502) communicatively coupled to the processor and adapted to store instructions which, when executed by the processor, cause the terminal device to perform operations of the method of any of Example Embodiments 1-35.

Example Embodiment 68. A terminal device adapted to perform the method of any of Example Embodiments 1-35.

Example Embodiment 69. A network node (700), comprising: a processor (701); and a memory (702) communicatively coupled to the processor and adapted to store instructions which, when executed by the processor, cause the network node to perform operations of the method of any of Example Embodiments 36-66.

Example Embodiment 70. A network node adapted to perform the method of any of Example Embodiments 36-66.

Example Embodiment 71. A wireless communication system (900), comprising: a terminal device (901) of Example Embodiment 67 or 68; and a network node (902) of Example Embodiment 69 or 70, communicating with at least the terminal device.

Example Embodiment 72. A non-transitory computer readable medium having a computer program stored thereon which, when executed by a set of one or more processors of a terminal device, causes the terminal device to perform operations of the method of any of Example Embodiments 1-35.

Example Embodiment 73. A non-transitory computer readable medium having a computer program stored thereon which, when executed by a set of one or more processors of a network node, causes the network node to perform operations of the method of any of Example Embodiments 36-66.

1. A method implemented by a terminal device, the method comprising:
transmitting, to a network node, information about a first preference of the terminal device to use a timing advance, TA, based propagation delay estimation or a round-trip time, RRT, based propagation delay estimation.

2.-17. (canceled)

18. A method by a network node, the method comprising:
receiving, from a terminal device, information about a first preference of the terminal device to use a timing advance, TA, based propagation delay estimation or a round-trip time, RRT, based propagation delay estimation.

19.-36. (canceled)

37. A terminal device adapted to:
transmit, to a network node, information about a first preference of the terminal device to use a timing advance, TA, based propagation delay estimation or a round-trip time, RRT, based propagation delay estimation.

38. The terminal device of claim 37, wherein the first preference comprises at least one of
a preference of the terminal device for at least one downlink reference signal;
a preference of the terminal device for at least one uplink reference signal; and
a preference of the terminal device for at least one physical random access channel, PRACH, transmission on an uplink.

39. The terminal device of claim 37, wherein the first preference indicates a preference of the terminal device to use a network node based propagation delay estimation or a terminal device based propagation delay estimation.

40. The terminal device of claim 39, wherein when the preference of the terminal device is to use network based propagation delay estimation, the terminal device is adapted to transmit an uplink signal with at least one characteristic to the network node, and wherein the at least one characteristic comprises a number of repetitions in time.

41. The terminal device of claim 37, further adapted to:
transmit, to the network node, information about a second preference of the terminal device to use a network node based compensation or a terminal device based compensation.

42. The terminal device of claim 41, wherein the information about the second preference of the terminal device is transmitted with the information about the first preference of the terminal device.

43. The terminal device of claim 41, wherein a field is added to a reference time delivery information element to indicate that a propagation delay has been compensated.

44. The terminal device of claim 37, further adapted to transmit, to the network node, a desired clock synchronization accuracy of the terminal device.

45. The terminal device of claim 37, wherein the first preference comprises a periodicity for refreshing a clock between the terminal device and the network node.

46. The terminal device of claim 37, wherein the first preference comprises a refresh moment with respect to a predetermined reference system.

47. The terminal device of claim 46, wherein the predetermined reference system comprises a reference system frame number, SFN.

48. The terminal device of claim 46, wherein the refresh moment is determined by:
indicating the refresh moment that is as close as possible to the predetermined reference system on a Uu interface.

49. The terminal device of claim 37, wherein the information about the first preference is transmitted in response to at least one of:
determining that the terminal device has not transmitted any information about the first preference after configuration of the terminal device by the network node;
determining that the first preference of the terminal device has changed from a last time the terminal device initiated transmission of information about the propagation delay; and
determining that the first preference of the terminal device is not the same as that configured by the network node.

50. The terminal device of claim 49, wherein when the terminal device determines that the first preference has changed or that the first preference is not the same as that configured by the network node, the terminal device is adapted to:
start a prohibit timer when the first preference is transmitted to the network node.

51. The terminal device of claim 37, wherein the information about the first preference of the terminal device is transmitted based on a selected PRACH resource, and wherein the PRACH resource is at least one of:
a PRACH time/frequency resource,
a PRACH preamble,
a PRACH sequence length,
a PRACH format,
a PRACH power ramping step,
PRACH back off time configuration, and
a set of single side bands, SSBs, associated with a PRACH occasion and the PRACH preamble.

52. The terminal device of claim 37, further adapted to:
upon initiation of an RRC connection reestablishment procedure or an RRC resume procedure, keep or release a configuration comprising at least one triggering condition for transmitting the first preference.

53. The terminal device of claim 52, further adapted to:
in response to releasing the configuration, stop at least one timer for the first preference for propagation delay estimation.

54. A network node adapted to:
receive, from a terminal device, information about a first preference of the terminal device to use a timing advance, TA, based propagation delay estimation or a round-trip time, RRT, based propagation delay estimation.

55. The network node of claim 54, adapted to:
select a configuration for clock synchronization between the network node and the terminal device based on the information about the first preference of the terminal device.

56. The network node of claim 54, adapted to:
based on the information about the first preference of the terminal device, determine whether the terminal device is a time sensitive network, TSN, terminal device or a non-TSN terminal device; and
determine or adjust at least one parameter associated with a propagation delay configuration based on whether the terminal device is determined to be the TSN terminal device or the non-TSN terminal device.

57. The network node of claim 54, adapted to:
determine whether the network node needs the information about the first preference of the terminal device; and
transmit, to the terminal device, a request for the information about the first preference.

58. The network node of claim 54, wherein the first preference comprises at least one of:
a preference of the terminal device for at least one downlink reference signal;
a preference of the terminal device for at least one uplink reference signal; and
a preference of the terminal device for at least one physical random access channel, PRACH, transmission on an uplink.

59. The network node of claim 54, wherein the first preference indicates a preference of the terminal device to use a network node based propagation delay estimation or a terminal device based propagation delay estimation.

60. The network node of claim 59, wherein when the preference of the terminal device is to use the network based propagation delay estimation, the method further comprises receiving an uplink signal with at least one characteristics from the terminal device, and wherein the at least one characteristic comprises a number of repetitions in time.

61.-72. (canceled)
